(19) United States
(12) Patent Application Publication
(10) Pub. No.: US 2007/0038795 A1
(43) Pub. Date: Feb. 15, 2007

(54) Asynchronous bus interface and processing method thereof

(75) Inventor: Noriko Kadomaru, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/289,477

(22) Filed: Nov. 30, 2005

(30) Foreign Application Priority Data
Aug. 10, 2005 (JP) 2005-231571

(51) Int. Cl. G06F 13/36; G06F 1/12

(52) U.S. Cl. 710/315; 713/400

(57) ABSTRACT

An asynchronous bus interface which is capable of securing a sufficient access effective period and eliminating a useless access wait time even when a frequency of a clock changes is provided. An asynchronous bus interface having an input part which inputs therein frequency information of a clock of a synchronous device which operates synchronously with the clock, and a signal generating part which generates a second access signal based on a first access signal when inputting therein the first access signal to an asynchronous device from the synchronous device, and outputs the second access signal to the asynchronous device is provided. The signal generating part determines a number of effective cycles of the second access signal in accordance with the frequency information of the clock.

### CROSS-REFERENCE TO RELATED APPLICATIONS

This application is based upon and claims the benefit of priority from the prior Japanese Patent Application No. 2005-231571, filed on Aug. 10, 2005, the entire contents of which are incorporated herein by reference.

### BACKGROUND OF THE INVENTION

1. Field of the Invention

The present invention relates to an asynchronous bus interface and a processing method thereof.

2. Description of the Related Art

FIG. 4 is a diagram showing a configuration of a system having a synchronous device (CPU) 402 and an asynchronous device 406. The central processing unit (CPU) 402, a clock generator 403 and an asynchronous bus interface 404 are connected to a system bus (synchronous bus) 401. The clock generator 403 generates a system clock CK and outputs it to the CPU 402 and the asynchronous bus interface 404. The CPU 402, the clock generator 403 and the asynchronous bus interface 404 input therein and output synchronous access signals, which are synchronous with the system clock CK, from and to one another via the system bus 401.

The asynchronous bus interface 404 and the asynchronous device 406 are connected to an asynchronous bus 405. The asynchronous device 406 and the asynchronous bus interface 404 input therein and output asynchronous access signals, which are asynchronous with the system clock CK, from and to each other via the asynchronous bus 405.

The CPU 402 supplies an access signal to the asynchronous device 406 via the asynchronous bus interface 404. When the asynchronous bus interface 404 inputs a first access signal therein from the CPU 402, it generates a second access signal based on the first access signal and outputs the second access signal to the asynchronous device 406.

FIG. 5 is a timing chart showing the clock CK and the second access signal. The second access signal is an access signal which the asynchronous bus interface 404 outputs to the asynchronous device 406.

A second access signal 501 needs to keep effective during a necessary set period 511 for the asynchronous device 406. The period 511 during which the second access signal 501 is kept effective is called an assertion cycle (effective cycle) period. When the asynchronous device 406 is connected to the synchronous system having the system clock CK which is the reference, the asynchronous bus interface 404 generates the second access signal 501 which is made effective during the period (assertion cycle period) 511 necessary for access of the asynchronous device 406 based on the number of cycles of the system clock CK. The asynchronous device 406 is generally slow in speed with respect to the synchronous device (CPU) 402, and therefore, the asset cycle period needs several cycles. When the number of assertion cycles is larger than one cycle, the synchronous system is in the state where it is kept waiting, and in this case, the assertion cycle is called a wait cycle.

In the electronic device systems in recent years, high speed and low power consumption are required, and therefore, it is demanded to dynamically switch the frequency of the system clock CK in accordance with the situation of the system (which means switching during supply of electric power). For example, when high-speed processing is required, the frequency of the system clock CK is made high, and during waiting and when a low-speed processing does not matter, the frequency of the system clock CK is made low, whereby electric power consumption is suppressed. As explained above, the second access signal to the asynchronous device 406 is generated based on the number of cycles of the system clock CK, and therefore, when the frequency of the system clock CK is switched, the assertion cycle period of the second access signal to the asynchronous device 406 also changes.

For example, when the clock generator 403 generates the clock CK at 50 MHz, the second access signal 501 is generated. The second access signal 501 has the assertion cycle period 511. The assertion cycle period corresponds to the number of cycles of three clocks CK at 50 MHz.

On the other hand, when the clock generator 403 generates the clock CK at 100 MHz, a second access signal 502 is generated. The second access signal 502 has an assertion cycle period 512. The assertion cycle period 512 corresponds to the number of cycles of three clocks CK at 100 MHz. Even if the frequency of the clock CK changes, the number of cycles (the number of cycles of three clocks CK) of the assertion cycle period of the second access signal is always generated as the same. As a result, the assertion cycle period 512 of the second access signal 502 becomes shorter than the assertion cycle period 511 of the second access signal 501, and the second access signal 502 cannot secure the necessary assertion cycle period. As a result, the problems of being incapable of having access to the asynchronous device 406 and the like occur.

When the frequency of the clock CK rises, one cycle period of the clock CK becomes short, and there is the possibility that a sufficient assertion cycle period cannot be taken. On the other hand, when the frequency of the clock CK lowers, the period of one cycle of the clock CK becomes long, and therefore, useless wait time is included.

The following Japanese Patent Application Laid-open No. 11-328003 describes a memory control system which performs an access control for a synchronous recording medium by generating a change clock of which time interval is changed by determining a frequency division ratio of a wait cycle constituting a wait time of the synchronous recording medium with a counter so as to be able to provide consistency in wait time when consistency of the wait time of access cycle of the synchronous recording medium is lost with respect to the wait time of the access cycle of an asynchronous recording medium, and by switching the change clock and the system clock signal with a selector and outputting one of them.

The following Japanese Patent Application Laid-open No. 9-114779 describes a wait control method of an information processing unit which makes each peripheral device selectively accessible by sending an address to an address decoder from a processor, wherein the processor has a function of causing wait number information to be included in each address bit of the device, ready timing signals are generated in a plurality of timings in a ready timing signal generating part, a corresponding ready timing signal is selected with a selector based on the wait number information included in an address, the ready timing signal is latched into a latch circuit as a ready signal in that timing to send it to the processor. To make the peripheral device having the ready output function accessible, the ready output of the device is selected with the selector.

The following Japanese Patent Application Laid-open No. 2002-132711 describes a memory controller constructed by including a wait set register in which the number of waits when accessing an external memory is previously set from a CPU, a wait set register for DMA transfer in which the number of waits at the time of single address DMA transfer to a memory for low-speed operation from a memory for high-speed operation among the external memories is previously set from the CPU, a selector that selectively outputs the number of waits which either one of the wait set register and the wait set register for DMA transfer has in accordance with a single address DMA transfer request and a memory access request, and a memory access control signal generating circuit that generates and outputs a memory access cycle in which the number of waits selected with the selector is inserted.

The following Japanese Patent Application Laid-open No. 63-163658 describes an information processing unit having a function of selectively inserting wait clocks for one to a plurality of clocks at a beginning or an end of a machine cycle constituted of a plurality of clocks.

### SUMMARY OF THE INVENTION

An object of the present invention is to provide an asynchronous bus interface and a processing method thereof capable of securing a sufficient access effective period (assertion cycle period of an access signal) and eliminating a useless access wait time even when a frequency of a clock changes.

According to one aspect of the present invention, an asynchronous bus interface having an input part which inputs therein frequency information of a clock of a synchronous device which operates synchronously with the clock, and a signal generating part which generates a second access signal based on a first access signal when inputting therein the first access signal to an asynchronous device from the synchronous device, and outputs the second access signal to the asynchronous device is provided. The signal generating part determines a number of effective cycles of the second access signal in accordance with the frequency information of the clock.

### BRIEF DESCRIPTION OF THE DRAWINGS

FIG. 1 is a diagram showing a configuration example of a system having a synchronous device (CPU) and an asynchronous device according to an embodiment of the present invention;

FIG. 2 is a diagram showing a configuration example of a table showing relationship of a frequency and a number of wait cycles (number of assertion cycles);

FIG. 3 is a timing chart showing an example of a clock and a second access signal according to the embodiment;

FIG. 4 is a diagram showing a configuration of a system having a synchronous device (CPU) and a asynchronous device; and

FIG. 5 is a timing chart showing an example of a clock and a second access signal.

### DETAILED DESCRIPTION OF THE PREFERRED EMBODIMENTS

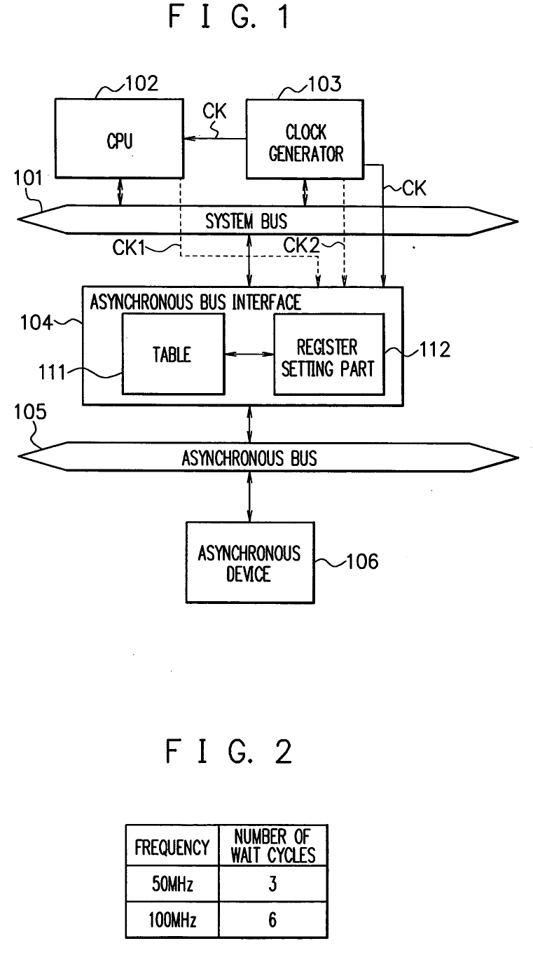

FIG. 1 is a diagram showing a configuration example of a system having a synchronous device (CPU) 102 and an asynchronous device 106 according to an embodiment of the present invention. The central processing unit (CPU) 102, a clock generator 103 and an asynchronous bus interface 104 are connected to a system bus (synchronous bus) 101. The clock generator 103 generates a system clock CK, and outputs it to the CUP 102 and the asynchronous bus interface 104. The CPU 102, the clock generator 103 and the asynchronous bus interface 104 input therein and output synchronous access signals, which are synchronous with the system clocks CK, from and to one another via the system bus 101.

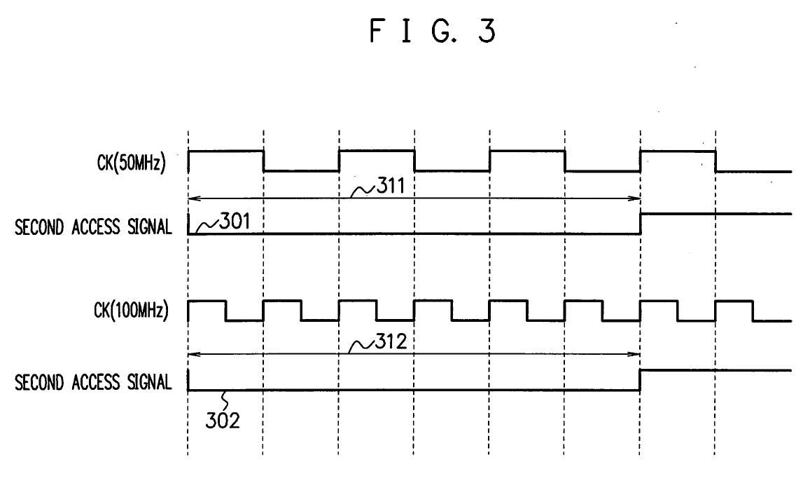

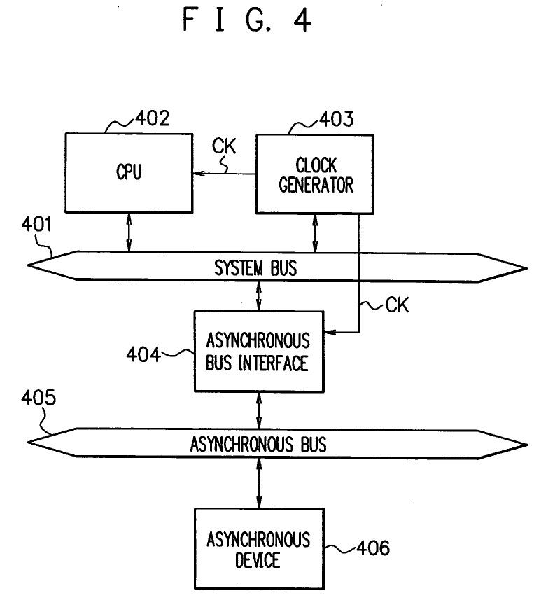

The CPU 102 can instruct the frequency of the clock CK to the clock generator 103 via the system bus 101. The clock generator 103 can generate the clocks CK at a plurality of kinds of frequencies corresponding to the instruction and can output them. Thereby, the CPU 102 can dynamically change the frequency of the clock CK in accordance with the situation of the system (changes the frequency during supply of electric power). For example, when a high-speed processing is required, the frequency of the clock CK is made high, and during waiting and when a low-speed processing does not matter, the frequency of the clock CK is made low, whereby electric power consumption is suppressed. The clock generator 103 can generate the clock CK at the low frequency of 50 MHz and the clock CK at the high frequency of 100 MHz as shown in FIG. 3, for example.

The asynchronous bus interface 104 and an asynchronous device 106 are connected to an asynchronous bus 105. The asynchronous device 106 and the asynchronous bus interface 104 input therein and output asynchronous access signals, which are asynchronous with the system clock CK, from and to each other via the asynchronous bus 105.

The CPU 102 supplies an access signal to the asynchronous device 106 via the asynchronous bus interface 104. When the first access signal is inputted in the asynchronous bus interface 104 from the CPU 102, the asynchronous bus interface 104 generates a second access signal based on the first access signal, and outputs it to the asynchronous device 106. The asynchronous bus interface 104 inputs therein the first access signal from the CPU 102 via the system bus 101 synchronously with the clock CK, and outputs the second access signal to the asynchronous device 106 via the asynchronous bus 105 asynchronously with the clock CK.

The asynchronous device 106 is, for example, a memory device such as a NAND type flash memory or a SRAM, and may be an I/O device or the like. The above described first access signal is a signal in conformity with the system bus interface, and is a predetermined command. The above described second access signal is a signal in conformity with the asynchronous bus interface, and is a signal capable of being directly inputted and outputted to and from the asynchronous device 106. The second access signal is, for example, a chip enable signal, a write enable signal, a read enable signal, a control signal necessary for access (for example, a ready (Ready) signal or the like), an address signal or a data signal.

The asynchronous bus interface 104 has a frequency information input terminal as an external terminal, directly inputs therein frequency information CK1 of the clock CK from the CPU 102, and can know the frequency of the clock CK. The asynchronous bus interface 104 has a table 111 and a register setting part 112.

FIG. 2 is a diagram showing a configuration example of the table 111 showing relationship of the frequency and the number of wait cycles (number of assertion cycles). The table 111 stores the relationship of the frequency and the number of wait cycles of the clock CK. For example, when the frequency of the clock CK is 50 MHz, the number of wait cycles is three, and when the frequency of the clock CK is 100 MHz, the number of wait cycles is six.

The register setting part 112 refers to the table 111, obtains the number of wait cycles corresponding to the frequency of the clock CK based on the frequency information CK1, and sets it in a register. The respective numbers of wait cycles necessary for generating various kinds of signals are set in the register. The present invention is not limited to the case where setting in the register is performed based on the table 111, but the number of wait cycles in accordance with the frequency information CK1 is obtained by referring to the table 111, and this number of wait cycles may be directly used.

When the asynchronous bus interface 104 inputs therein the first access signal to the asynchronous device 106 from the CPU 102 via the system bus 101, the asynchronous bus interface 104 generates the second access signal based on the first access signal and outputs it to the asynchronous device 106 via the asynchronous bus 105. On this occasion, the asynchronous bus interface 104 determines the number of assertion cycles (effective cycles) of the second access signal based on the number of wait cycles which is set in the register, and generates the second access signal.

FIG. 3 is a timing chart showing an example of the clock CK and the second access signal according to this embodiment. The second access signal is the access signal which the asynchronous bus interface 104 outputs to the asynchronous device 106.

When the clock CK at 50 MHz is generated by the clock generator 103, the asynchronous bus interface 104 generates a second access signal 301 and outputs it to the asynchronous device 106. The second access signal 301 has an assertion cycle period 311. The assertion cycle period 311 is an access effective period necessary for access of the asynchronous device 106. The number of cycles of the assertion cycle period 311 is determined based on the table 111 as described above. The asynchronous bus interface 104 can know the frequency of the clock CK is 50 MHz based on the frequency information CK1. Then, the asynchronous bus interface 104 refers to the table 111 in FIG. 2 and finds that the frequency of the clock CK is 50 MHz, and therefore, determines the number of wait cycles to be three. The number of wait cycles corresponds to the number of cycles of the assertion cycle period 311. Thus, the asynchronous bus interface 104 generates the second access signal 301 of which number of cycles of the assertion cycle period 311 corresponds to the number of cycles of three clocks CK.

When the clock CK at 100 MHz is generated by the clock generator 103, the asynchronous bus interface 104 generates a second access signal 302 and outputs it to the asynchronous device 106. The second access signal 302 has an assertion cycle period 312. The assertion cycle period 312 is an access effective period necessary for access of the asynchronous device 106. The number of cycles of the assertion cycle period 312 is determined based on the table 111 as described above. The asynchronous bus interface 104 can know that the frequency of the clock CK is 100 MHz based on the frequency information CK1. Then, the asynchronous bus interface 104 refers to the table 111 in FIG. 2 and finds that the frequency of the clock CK is 100 MHz, and therefore, determines the number of wait cycles to be six. The number of wait cycles corresponds to the number of cycles of the assertion cycle period 312. Thus, the asynchronous bus interface 104 generates the second access signal 302 of which number of cycles of the assertion cycle period 312 corresponds to the number of cycles of six clocks CK.

The second access signal is, for example, a chip enable signal, a write enable signal, a read enable signal, a control signal necessary for access, an address signal or a data signal. When the second access signal is an address signal or a data signal, the assertion cycle period means the period in which the signal necessary for access is effective.

As described above, according to this embodiment, when the asynchronous bus interface 104 inputs therein the frequency information CK1 of the clock CK of the synchronous device 102 which operates synchronously with the clock CK, and inputs therein the first access signal to the asynchronous device 106 from the synchronous device (CPU) 102, the asynchronous bus interface 104 generates the second access signal based on the first access signal and outputs it to the asynchronous device 106. On this occasion, the asynchronous bus interface 104 determines the number of assertion cycles of the second access signal in accordance with the frequency information CK1 of the clock CK.

When high-speed processing is required, the frequency of the clock CK is made high, and during waiting and in the case of low-speed processing, the frequency of the clock CK is made low, whereby electric power consumption can be suppressed. When the frequency of the clock CK rises, the number of assertion cycles is increased, and when the frequency of the clock CK lowers, the number of assertion cycles is decreased. Namely, as shown in FIG. 2, the number of assertion cycles (the number of wait cycles) of the second access signal becomes larger as the frequency of the clock CK is higher. For example, when the frequency of the clock CK increases by n times, the number of assertion cycles of the second access signal increases by n times.

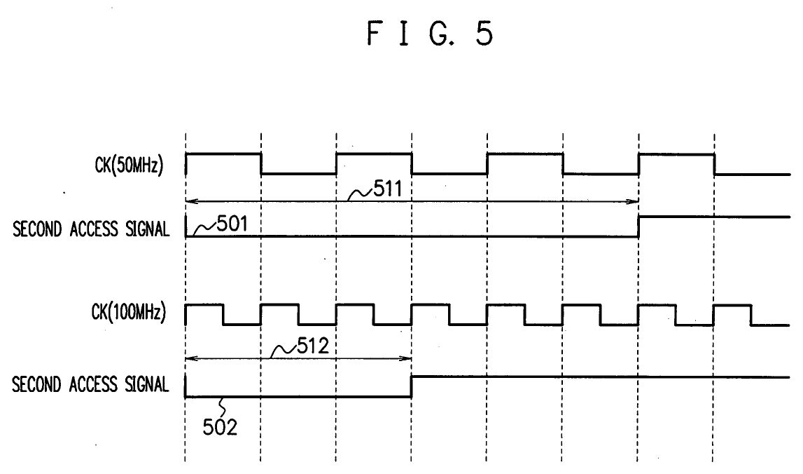

In the case of FIG. 5, when the frequency of the clock CK changes, the assertion cycle period of the second access signal changes. When the frequency of the clock CK rises, the period of one cycle of the clock CK becomes short, and there is the possibility that the sufficient assertion cycle period cannot be taken. On the other hand, when the frequency of the clock CK lowers, the period of one cycle of the clock CK becomes long, and therefore, a useless wait time is included.

According to this embodiment, the number of assertion cycles of the second access signal is determined in accordance with the frequency information CK1 of the clock CK, and therefore, even if the frequency of the clock CK changes, the assertion cycle periods 311 and 312 of the second access signal can be kept substantially constant. Thereby, even when the frequency of the clock CK changes, a sufficient assertion cycle period can be secured. Besides, a useless access wait time can be eliminated. When the frequency of the clock CK dynamically changes, the asynchronous bus interface 104 dynamically determines the number of assertion cycles of the second access signal, and therefore, even if the frequency of the clock CK changes, it is not necessary to turn on the power supply again or to trigger a reset to change the number of assertion cycles.

If the CPU 102 is to perform resetting of the corresponding register of the asynchronous bus interface 104 when the frequency of the clock CK is dynamically switched, the CPU 102 needs to access (rewrite of the register using the system bus 101 and the external terminal) the asynchronous bus interface 104 for register setting every time the clock CK changes, and therefore, the performance of the system decreases. Since the asynchronous bus interface 104 itself performs setting of the register in this embodiment, the CPU 102 does not need to access the asynchronous bus interface 104, and therefore, decrease in performance of the system can be prevented.

The asynchronous bus interface 104 may input the frequency information CK2 in a frequency information input terminal from the clock generator 103 instead of inputting the frequency information CK1 therein from the CPU 102. The frequency information CK1 and CK2 may be the information indicating that the frequency of the clock CK changes. The asynchronous bus interface 104 may input therein the frequency information from the CPU 102 or the clock generator 103 via the system bus 101. The asynchronous bus interface 104 may detect the frequency based on the clock CK inputted therein from the clock generator 103, and may input therein the frequency information.

The number of effective cycles of the second access signal is determined in accordance with the frequency information of the clock, and therefore, even when the frequency of the clock changes, a sufficient access effective period (assertion cycle period of the access signal) can be secured. Besides, a useless access wait time can be eliminated.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. An asynchronous bus interface, comprising:
an input part which inputs therein frequency information of a clock of a synchronous device which operates synchronously with the clock; and
a signal generating part which generates a second access signal based on a first access signal when inputting therein the first access signal to an asynchronous device from the synchronous device, and outputs the second access signal to the asynchronous device,
wherein said signal generating part determines a number of effective cycles of the second access signal in accordance with frequency information of the clock.

2. The asynchronous bus interface according to claim 1, wherein said signal generating part inputs therein the first access signal from the synchronous device synchronously with the clock, and outputs the second access signal to the asynchronous device asynchronously with the clock.

3. The asynchronous bus interface according to claim 2, wherein said signal generating part inputs therein the first access signal from the synchronous device via a synchronous bus, and outputs the second access signal to the asynchronous device via an asynchronous bus.

4. The asynchronous bus interface according to claim 1, wherein when a frequency of the clock increases by n times, the number of effective cycles of the second access signal increases by n times.

5. The asynchronous bus interface according to claim 1, wherein said signal generating part determines the number of effective cycles of the second access signal based on a table showing relationship of the frequency of the clock and the number of effective cycles.

6. A processing method of an asynchronous bus interface, comprising:
an inputting step inputting therein frequency information of a clock of a synchronous device which operates synchronously with the clock; and
a signal generating step generating a second access signal based on a first access signal when inputting therein the first access signal to an asynchronous device from the synchronous device, and outputting the second access signal to the asynchronous device,
wherein said signal generating step determines a number of effective cycles of the second access signal in accordance with the frequency information of the clock.

7. The processing method of an asynchronous bus interface according to claim 6, wherein said signal generating step inputs therein the first access signal from the synchronous device synchronously with the clock, and outputs the second access signal to the asynchronous device asynchronously with the clock.

8. The processing method of an asynchronous bus interface according to claim 7, wherein said signal generating step inputs therein the first access signal from the synchronous device via a synchronous bus, and outputs the second access signal to the asynchronous device via an asynchronous bus.

9. The processing method of an asynchronous bus interface according to claim 6, wherein the frequency of the clock increases by n times, the number of effective cycles of the second access signal increases by n times.

10. The processing method of an asynchronous bus interface according to claim 6, wherein said signal generating step determines the number of effective cycles of the second access signal based on a table showing relationship of the frequency of the clock and the number of effective cycles.
